(19) United States
(12) Patent Application Publication
(10) Pub. No.: US 2002/0059153 A1
(43) Pub. Date: May 16, 2002

(54) Toy learning apparatus using cyber community and performance method thereof

(75) Inventors: Byung Ju Dan, Sungnam (KR); Jong Rak Lim, Yongln (KR); Jae Ho Na, Kuri (KR); Jang Won Boo, Seoul (KR); Hee II Wang, Seoul (KR); Nam Woong Kim, Seoul (KR); In Sang Song, Uiwang (KR); Wae Yeul Kim, Seoul (KR)

Correspondence Address: JONATHAN Y. KANG, ESQ., LEE & HONG P.C., 11th Floor, 221 N. Figueroa Street, Los Angeles, CA, 90012-2601, US

(73) Assignee: LG Electronics Inc.

(21) Appl. No.: 09/931,362

(22) Filed: Aug. 16, 2001

(30) Foreign Application Priority Data
Aug. 18, 2000 (KR) 2000-47829

(51) Int. Cl. G06F 15/18

(52) U.S. Cl. 706/25; 706/62

(57) ABSTRACT

A toy learning apparatus using a cyber community and a method thereof comprising a cyber community having a cyber character which grows by learning in online, and a toy which grows by receiving experience of the cyber character or experience of a user's learning can increase the interest of the user, promote the sale of the toy and supply the program update of the toy, contents and various kinds of information smoothly by connecting the actual toy and the cyber character which acts in the cyber community.

### BACKGROUND OF THE INVENTION

1. Field of the Invention

The present invention relates to a learning/growing toy and particularly, a toy learning apparatus using a cyber community and a method thereof wherein a toy grown in offline and a cyber character grown in a cyber community can exchange information.

2. Description of the Background Art

Generally, a learning/growing toy is an intelligent toy which has a program that can have the toy react to a command of a user using the art of remote controlling command and voice recognition or grow through learning for a certain time. For example, such a toy has a program which enables the toy to interact to learning according to actions as voice, sound, light and contact. Namely, the toy has a program which enables the toy to grow intelligently and functionally responding to the learning of the user in offline.

However, if a certain time passes after buying the toy, the grown appearance of the toy finally shows a simplified pattern due to the limited learning guidance, instruction and memory. Also, the toy has a disadvantage that a variety of learning chances can not provided and various interests can not be induced since the toy can grow only by individual learning without a comparison means with another users.

### SUMMARY OF THE INVENTION

Therefore, an object of the present invention is to provide a toy learning apparatus using a cyber community and a method thereof by composing a toy so that the toy grows in offline, the cyber character grown in offline can exchange information with the cyber character grown in the cyber community, induce various interests of the real world and compare the toy with the toy of another users thus to have the toy grow corresponding to the interest or taste of the user.

To achieve these and other advantages and in accordance with the purpose of the present invention, as embodied and broadly described herein, there is provided a toy learning apparatus using a cyber community is composed of a cyber community having a cyber character which grows by learning in online and a toy which grows by receiving experience of the cyber character or experience of a user's learning.

To achieve the above object, there is provided a toy learning method using a cyber community is comprised the steps of reflecting the experience information of the toy on the activity of the cyber character in the cyber community by transmitting the experience information to the cyber community, having the toy learn by transmitting the experience information according to the activity of the cyber character in the cyber community and upgrading the operating/application program corresponding to the extent of learning of the toy.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram showing the interaction of respective parts in accordance with the present invention;

FIG. 2 is an exemplary illustration showing a cyber community built in online in accordance with the present invention;

FIG. 3 is an exemplary illustration showing a data exchange information of the cyber character and the toy in accordance with the present invention;

FIG. 4 is a block diagram showing the flow of data among the network server, performance apparatus and toy; and

FIG. 5 is a flow chart showing the method of toy growth by user mode selection in accordance with the present invention.

### DETAILED DESCRIPTION OF THE PREFERRED EMBODIMENTS

Reference will now be made in detail to the preferred embodiments of the present invention, examples of which are illustrated in the accompanying drawings.

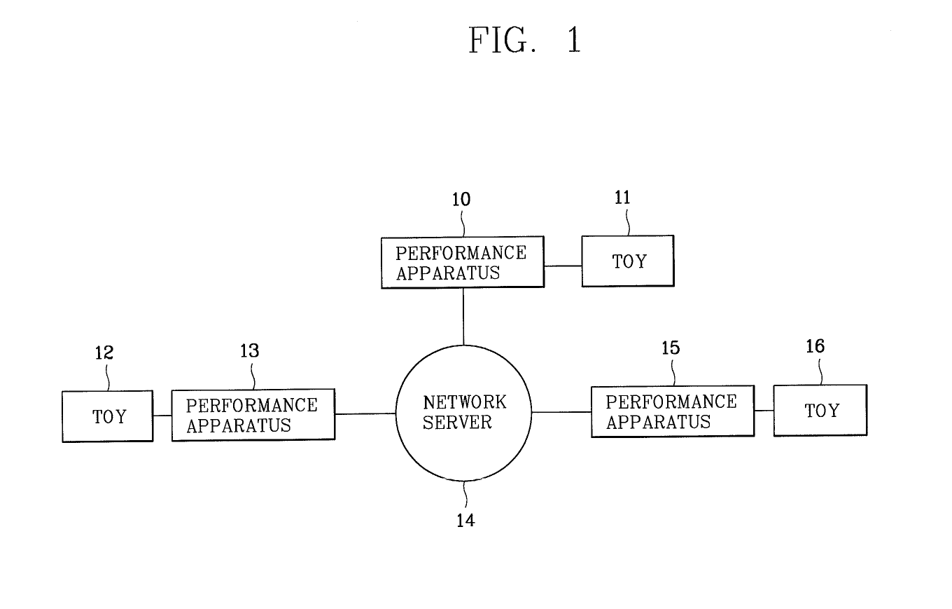

FIG. 1 is a block diagram showing the interaction of respective parts in accordance with the present invention and as shown in the drawing, the toy learning apparatus using a cyber community comprises a cyber community having a cyber character which grows by learning in online, and a toy which grows by receiving experience of the cyber character or experience of a user's learning. Here, the cyber community comprises a network server for supplying information of the cyber character of a different user and an operation data for the toy and a performance apparatus for outputting the information of the cyber character to the toy and providing an upgrade program provided from the network server.

Namely, the network server 14 manages and adjusts cyber characters of another users and provides programs for synchronizing the cyber community are provided to respective users. The toys 11, 12 and 16 have a sensor for sensing an outside pulsation, an input apparatus for inputting an image, audio information and letters, and a communication apparatus for wire and wireless communication. The performance units 10, 13 and 15 are a computer, a mobile phone and a PDA, which have wire and wireless communication functions thus to provide the contents information provided from the network server 14 and upgraded programs for managing the toy.

The method for performing the toy using the cyber community in accordance with the present invention will be described as follows.

A user stores learned contents in the memory (not shown) by adjusting a certain part of the toy or controlling the remote controller or having the a toy learn using a information input means such as audio information after buying the toy. After storing, the toys 11, 12 and 16 and the performance units 10, 13 and 15 are connected and the experience information of the toys 11, 12 and 16 is transmitted to the network server 14. Then, the experience information is reflected on the action of the cyber character in the cyber community. To the contrary, the experience information by the cyber character is transmitted from the network server to the toys 11, 12 and 16 and accordingly, the toys 11, 12 and 16 learn and the operating/application program is upgraded corresponding to the learning.

Namely, the experience of the current status of the toys 11, 12 and 16, such as a character, degree of growth and physical status, formed in offline is transmitted to the cyber character in the cyber community in online and affects the action in the cyber community and accordingly, the experience of the cyber character in the cyber community affects the current status of the toys thus to change the action of the toys.

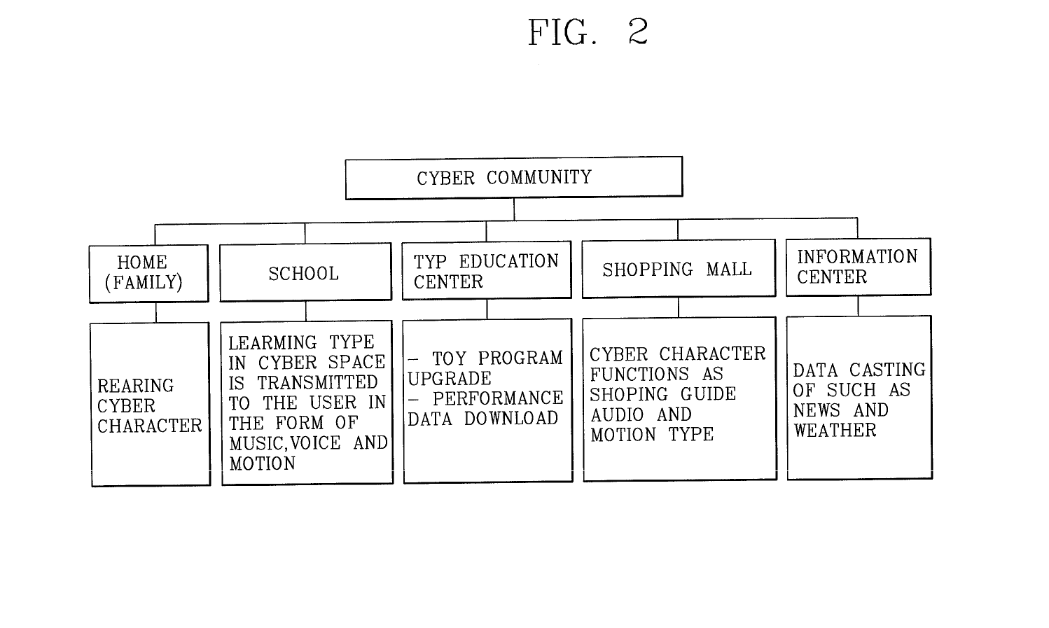

FIG. 2 is an exemplary illustration showing a cyber community built in online in accordance with the present invention and as shown in the drawing, the cyber community is a copy of the daily life of mankind and different cyber communities with a same concept can exchange information each other. Here, in the respective cyber communities, cyber characters can be made and the cyber character is composed of a cyber character which exists only in a cyber community and a cyber character of a user who represents the toy in the real world. Therefore, those cyber characters can meet, talk as in the daily life, get necessary information visiting prepared rooms and have entertainment.

Namely, the cyber community comprises a house (family) for rearing a cyber character, a school in which the cyber character learns audio information such as music and voice, motion and gesture, and a robot education center for upgrading program of the cyber character or downloading operation data and an information center for providing data such as a shopping mall, news and weather while the cyber character acts as a shopping guide. Accordingly, the cyber character can perform the process of getting necessary information in the cyber community by talking with another cyber characters and visiting the prepared rooms as in the daily life.

Therefore, the information about the experience of the cyber character which is obtained and learned in the whole action process is provided as information for having the toys 11, 12 and 16 in offline learn. Also, the expressive information such as a motion of the cyber character, which obtained in the cyber community, gesture and audio information can be operated in the toy in offline.

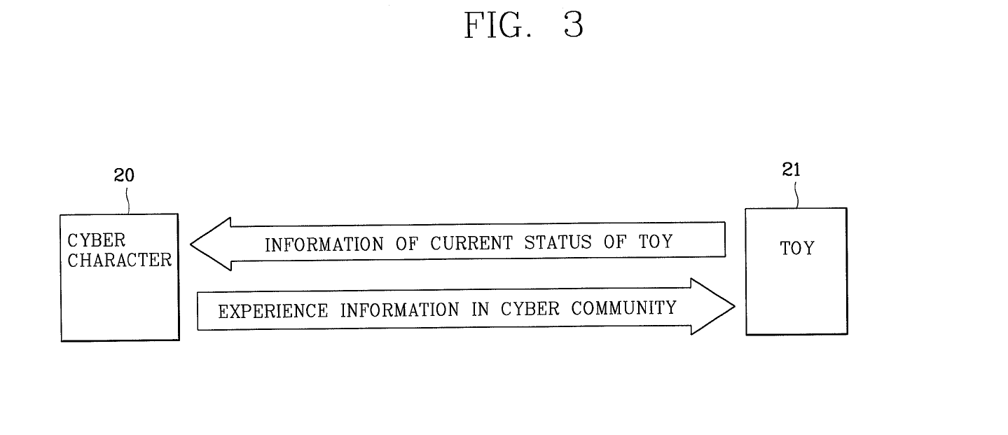

FIG. 3 is an exemplary illustration a data exchange information of the cyber character and the toy in accordance with the present invention and the cyber character 20 which exists in the online cyber community and the toy 21 in offline exchange information through the performance apparatus (not shown) and the cyber character 20 and the toy 21 reflect experience of each other. Here, the cyber character 20 and the toy 21 has a sensor for sensing the outside stimulation, input apparatus for inputting an image, audio information and letters and a communication apparatus for wire and wireless communication, and accordingly, the components can contact with the cyber character 20 which exists in the online cyber community.

Therefore, the experience information such as the status of feeling of the toy 21 formed in offline, degree of growth, degree of intelligence and physical status is transmitted to the cyber character in the online cyber community and accordingly, the information affects the action of the cyber character 20 in the cyber community. Also, the product information of the cyber character 20 in the online cyber community, educational contents, news, weather and the experience in the cyber community affects the toy 21 in offline thus to change the action of the toy 21.

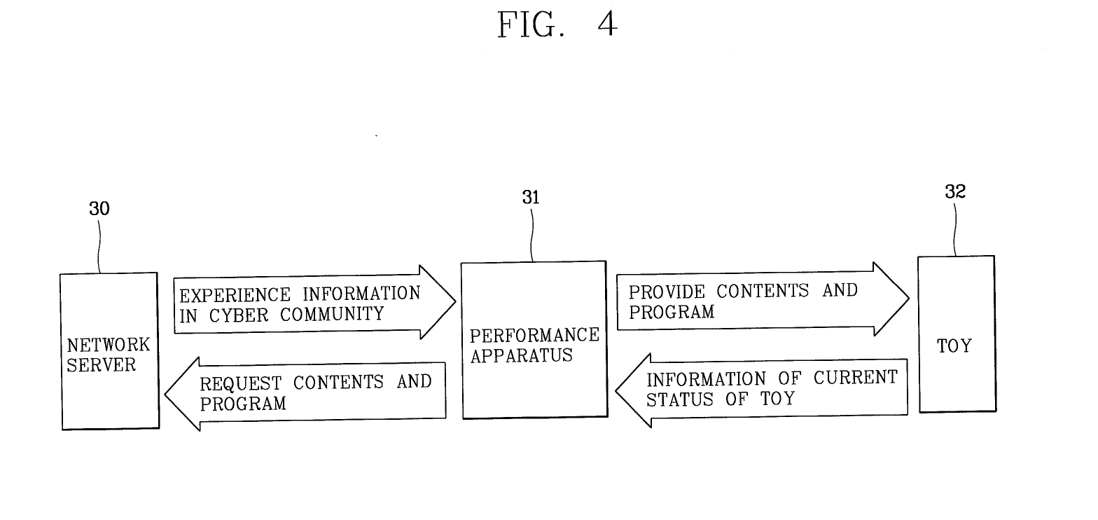

FIG. 4 is a block diagram showing the flow of data among the network server, performance apparatus and toy and as shown in the drawing, the user adjusts a certain part or controls the remote controller or has the toy 32 learn using the information input means such as an audio information after buying the toy 32 and stores the experience information in the memory (not shown).

The experience information about the toy 32 is provided to the network server by connecting with the network server through the performance apparatus 31. At this time, the user connects with the network server 30 by inputting the pre-given ID to connect to the cyber community which the network server provides.

Later, the information such as the degree of growth and degree of the intelligence, learning result, status of feeling, type of character and physical status is provided to the network server 30 and the various kinds of information is reflected upon the action of the cyber character which represent the toy.

To keep up with this, the network server 30 provides the information of contents or program about the toy to the performance apparatus 31 and at the same time, provides the information about the cyber character of another user to the performance apparatus 31 together.

At this time, the performance apparatus 31 is provided the upgraded contents and program by the network server and accordingly, the performance apparatus 31 provides the upgraded program to the toy 32 in offline. For example, by transmitting the motion, gesture, the operation data as the audio information, information such as news, weather, shopping and experience information of the cyber character in the cyber community from the cyber character to the toy 32 to have the toy 32 learn.

Therefore, the toy 32 stores the information obtained by learning of the user and experience of the cyber character and learns. By operating the upgraded program about the toy provided reflecting the context of the learning, the toy 32 exhibits a certain motion or outputs an audio information such as voice/sound.

On the other hand, as an embodiment of the present invention for reducing the amount of data transmitted between the network server 30 and the performance apparatus 31, the cyber community is operated in the performance apparatus 31.

Namely, the network server 30 synchronizes the operation of the cyber community in a plurality of performance apparatuses 31 which are connected to the network server 30 and accordingly, it makes as if the user is connected to the cyber community which is operated in the network server.

At this time, the respective performance apparatuses 31 transmit a requesting signal for providing contents such as operation status information, required information and operation data to synchronize the operation of the cyber community to the network server 30 and the network server 30 transmits the operation synchronizing control signal and the required information to the respective performance apparatuses. Therefore, the burden of transmitting mass capacity programs to operate the cyber community to the respective performance apparatuses 31.

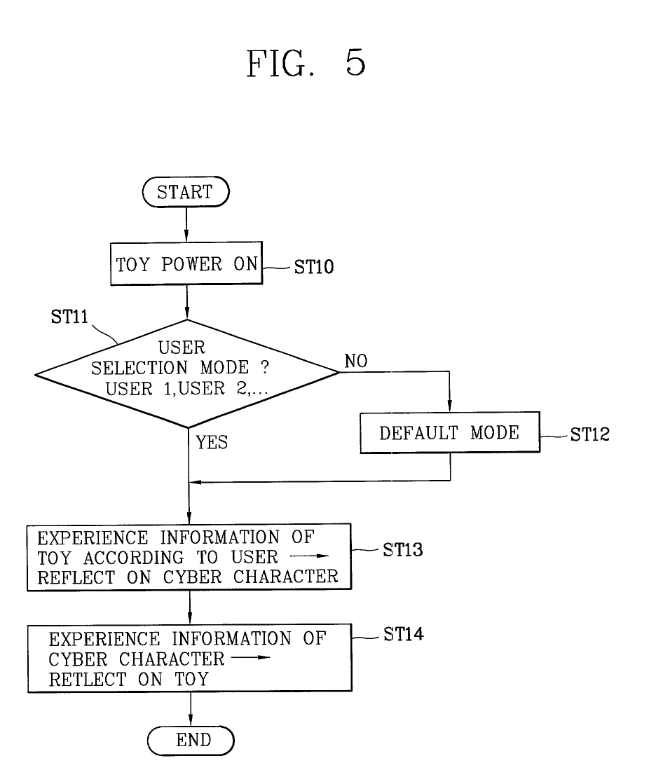

On the other hand, as shown in FIG. 5 which is another embodiment of the present invention for performing the toy as a toy having various experience information, the user can have the toy grow as a toy having various experience satisfying the taste of many users by comprising the steps of turning on the power supply of the toy ST 10, selecting a user questioning the mode of the user by the toy ST11, selecting a default user in case the user mode is not selected ST12, reflecting the experience information of the toy on the cyber character in online according to the selected user and accordingly, changing the activity of the cyber community ST13, and reflecting the experience of the cyber character in the cyber community in online on the current status of the toy and changing the action of the toy ST14.

Also, as another embodiment of the present invention for joint experience information about the toy of another users, the toy can be composed as each toy has a memory or the input and output apparatus for providing information to the toys to exchange information. Namely, the toy can grow as a toy having different experience by having many memories in a toy and exchanging each memory or act remaining the information about the experience by replacing the memory only even though the user buys a new toy using the method of detachable memory attachment. Also, the method can exchange information with the cyber character in the cyber community by mounting the memory of the user in the toy of another user. Therefore, the toy can have various experiences using a toy by composing the toy so that the toy grown by the user in online and the cyber character grown by another users joint their experience.

As apparent from the above description, the present invention can have the actual toy grow by operating it in various circumstances by connecting the actual toy and the cyber character which acts in the cyber community and accordingly, the present invention can increase the interest of the user, promote the sale of the toy and supply the program update of the toy, contents and various kinds of information smoothly.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A toy learning apparatus using a cyber community comprising:
a cyber community having a cyber character which grows by learning in online; and
a toy which grows by receiving experience of the cyber character or experience of a user's learning.

2. The apparatus of claim 1, wherein the cyber community is performed in a network server which provides cyber character information of a user and cyber character information of another user.

3. The apparatus of claim 1, wherein the cyber community is performed in a performance apparatus for outputting the information of the cyber character.

4. The apparatus of claim 1, wherein the cyber community is performed in a network server for supplying an operation data for the toy and a performance apparatus for providing an upgrade program provided from the network server.

5. The apparatus of claim 1, wherein the cyber community comprising:
a home (family) for rearing a cyber character;
a school in which the cyber character learns audio information such as music and voice, motion and gesture; and
a robot education center for upgrading program of the cyber character or downloading operation data and an information center for providing data such as a shopping mall, news and weather while the cyber character acts as a shopping guide.

6. The apparatus of claim 2 , wherein the network server is characterized that programs for synchronizing the cyber community are provided to respective users to contact with the cyber character of another users.

7. The apparatus of claim 1, wherein the cyber character is composed of a cyber character which exists only in a cyber community and a cyber character of a user who represents the toy in the real world.

8. The apparatus of claim 1, wherein the performance apparatuses are a computer, mobile phone and PDA, which have wire and wireless communication functions.

9. The apparatus of claim 1, wherein the toy exhibits motion of a level corresponding to experience of the cyber character in the cyber community and learning by the user or outputting an audio information.

10. The apparatus of claim 1, wherein the toy comprising:
a sensor for sensing an outside pulsation;
an input apparatus for inputting an image, audio information and letters; and
a communication apparatus for wire and wireless communication.

11. The apparatus of claim 1, wherein the toy has a memory for memorize the information by learning and an input/output unit for exchanging information with another toys.

12. The apparatus of claim 11, wherein the memory of the toy is detachable and can be replaced by a memory of another user.

13. The toy learning method using a cyber community comprising the steps of:
having the toy study by controlling a certain part of the toy or a remote controller or using an information input means such as an audio information and then storing the experience information in the memory;
reflecting the experience information of the toy on the activity of the cyber character in the cyber community according to the experience information of the toy by transmitting the experience information to the network server;
having the toy learn by transmitting the experience information according to the activity of the cyber character in the cyber community; and
upgrading the operating/application program corresponding to the extent of learning of the toy.

14. The method of claim 13, wherein the performance apparatus is used to operate the cyber community by downloading the program for operating the cyber community and the data information from the network server to reduce the amount of data which is transmitted between the network server and the performance unit.

15. The method of claim 14, comprising the steps of:
reflecting the information such as the learning result, characteristic, state of feeling and the degree of growth/intelligence on the activity of the cyber character which represents the toy in the cyber community; and
reflecting the experience information by the activity of the cyber character on the activity of the toy by transmitting it to the toy.

16. The method of claim 15, further having the step of updating the operating/application program corresponding to the extent of learning of the toy.

17. The method of claim 13, wherein the memory of the toy has a number of memories in a toy and accordingly, the memories have the toy grow to have different experiences respectively by replacing the respective memories.

18. The toy comprising the steps of:
turning on the power supply of the toy;
selecting a user questioning the mode of the user by the toy;
selecting a default user in case the user mode is not selected;
reflecting the experience information of the toy on the cyber character in online according to the selected user and accordingly, changing the activity of the cyber community; and
reflecting the experience of the cyber character in the cyber community in online on the current status of the toy and changing the action of the toy.
